(19) United States
(12) Patent Application Publication
(10) Pub. No.: US 2013/0119957 A1
(43) Pub. Date: May 16, 2013

(54) Bi-directional Switching Regulator and Control Circuit Thereof

(71) Applicant: Nien-Hui Kung, Hsinchu City (TW)

(72) Inventor: Nien-Hui Kung, Hsinchu City (TW)

(73) Assignee: Richtek Technology Corporation, R.O.C.

(21) Appl. No.: 13/294,203

(22) Filed: Nov. 11, 2011

(51) Int. Cl. G05F 5/00

(52) U.S. Cl. 323/299

(57) ABSTRACT

The present invention discloses a bi-directional switching regulator and its control circuit, wherein the bi-directional switching regulator converts an input voltage to an output voltage in a power supply mode, and it includes: a power stage including an upper gate switch, a lower gate switch and an inductor coupled to a common switching node, wherein the inductor is coupled to the input voltage; a load switch coupled between the output voltage and the upper gate switch; and a driver circuit controlling the load switch to adjust an output current flowing through the load switch according to current information at an input terminal of the input voltage.

### BACKGROUND OF THE INVENTION

1. Field of Invention

The present invention relates to a bi-directional switching regulator and its control circuit, in particular to a bi-directional switching regulator that detects an input current to adjust an output current in a power supply mode, and a control circuit thereof.

2. Description of Related Art

FIG. 1 shows a schematic diagram of a prior art bi-directional switching regulator 10 which can operate in a power supply mode or a charger mode. In the power supply mode, the bi-directional switching regulator 10 converts a lower input voltage Vin to a higher output voltage Vout; the terminal of the input voltage Vin is connected to a battery Bat, and the terminal of the output voltage Vout is connected to a load. If the terminal of the output voltage Vout is connected to a power supply (not shown) instead of the load, the bi-directional switching regulator 10 becomes a charger to the battery and operates in the charger mode. The circuit in FIG. 1 then becomes a buck switching regulator; the power stage 13 converts a higher voltage from the power supply at the terminal of the output voltage Vout to a lower voltage at the terminal of the input voltage Vin to charge the battery Bat.

The power stage 13 includes an upper gate switch M2, a lower gate switch M1 and an inductor L which are all coupled to one switching node LX. A current from the battery Bat flows through a resistor RS, the inductor L and the upper gate switch M2, and then flows through a node VX to the terminal of the output voltage Vout. If the node VX is directly used as the output terminal for supplying the output voltage Vout (that is, the circuit does not include the load switch M3, the driver circuit 11 and the error amplifier 12), when a short circuit or an abnormal overload occurs at the output terminal, the power stage 13 will keep operating to crash the switching regulator 10, and the over current will damage the circuit. To avoid circuit crash, an output short circuit protection circuit is usually used in a boost switching regulator, that is, a load switch M3 is placed between the node VX and the output voltage Vout to control the output current flowing through this load switch M3, as shown in FIG. 1. In the prior art shown in the figure, the load switch M3 is controlled by a driver circuit 11 to adjust the output current flowing to the terminal of the output voltage Vout. According to an error signal Comp from the error amplifier 12, the driver circuit 11 generates a switch signal to control the load switch M3. The error amplifier 12 compares a voltage at the node VX with the output voltage Vout to generate the error signal Comp.

However, as shown in FIG. 2, when the load switch M2 is switching from a linear mode to a saturation mode, if an abnormal overload or an overshoot problem occurs, the load switch M3 still cannot effectively control the output current Iout or prevent the circuit from crashing. Even though the load switch M3 can immediately limit the output current Iout to mitigate the over-current problem, the battery Bat may still be damaged because of over-discharging. The upper limit of the battery current Ibat is an important parameter and the battery current Ibat should be strictly limited below the upper limit. Although the prior art bi-directional switching regulator 10 may be able to control the output current Iout, the battery current Ibat is not subject to any instant control to be always under the upper limit, so the battery is not properly protected.

In the view of above, the present invention proposes a bi-directional switching regulator and its control circuit, which can prevent the battery current Ibat from exceeding the upper limit to keep the circuit and the battery Bat from being damaged by the over-current problem.

### SUMMARY OF THE INVENTION

An objective of the present invention is to provide a bi-directional switching regulator.

Another objective of the present invention is to provide a control circuit of a bi-directional switching regulator.

To achieve the foregoing objectives, in one perspective of the present invention, it provides a bi-directional switching regulator converting an input voltage to an output voltage in a power supply mode, the bi-directional switching regulator comprising: a power stage including an upper gate switch, a lower gate switch and an inductor coupled to a common switching node, wherein the inductor is coupled to the input voltage; a load switch coupled between the output voltage and the upper gate switch; and a driver circuit controlling the load switch to adjust an output current flowing through the load switch according to current information at an input terminal of the input voltage.

In one preferable embodiment, the bi-directional switching regulator further includes a resistor coupled between the inductor and the input voltage, wherein the current information is a voltage difference between two terminals of the resistor.

In one preferable embodiment, the bi-directional switching regulator further includes an error amplifier comparing voltages at the two terminals of the resistor to generate an error signal which is sent to the driver circuit.

In one preferable embodiment, both the upper gate switch and the lower gate switch are transistors.

In a charger mode, the bi-directional switching regulator charges a terminal of the input voltage from a terminal connected to the output voltage.

In another perspective of the present invention, it provides a control circuit of a bi-directional switching regulator, in a power supply mode, the control circuit controlling an input current from an input terminal through an inductor to generate an output current which is supplied to an output terminal, the control circuit comprising: an error amplifier detecting a voltage difference related to the input current to generate a error signal; a lower gate switch; an upper gate switch coupled to the lower gate switch and the inductor at a common switching node; a load switch coupled between the output terminal and the upper gate switch; and a driver circuit controlling the load switch according to the error signal to adjust the output current flowing through the load switch.

The objectives, technical details, features, and effects of the present invention will be better understood with regard to the detailed description of the embodiments below, with reference to the drawings.

### BRIEF DESCRIPTION OF THE DRAWINGS

FIG. 1 shows a schematic diagram of a prior art bi-directional switching regulator.

FIG. 2 shows a waveform of the output current Iout of the prior art bi-directional switching regulator.

FIG. 3 shows an embodiment of a bi-directional switching regulator according to the present invention.

FIG. 4 shows a waveform of the output current Iout of the bi-directional switching regulator according to the present invention.

FIG. 5 shows another embodiment of a power stage according to the present invention.

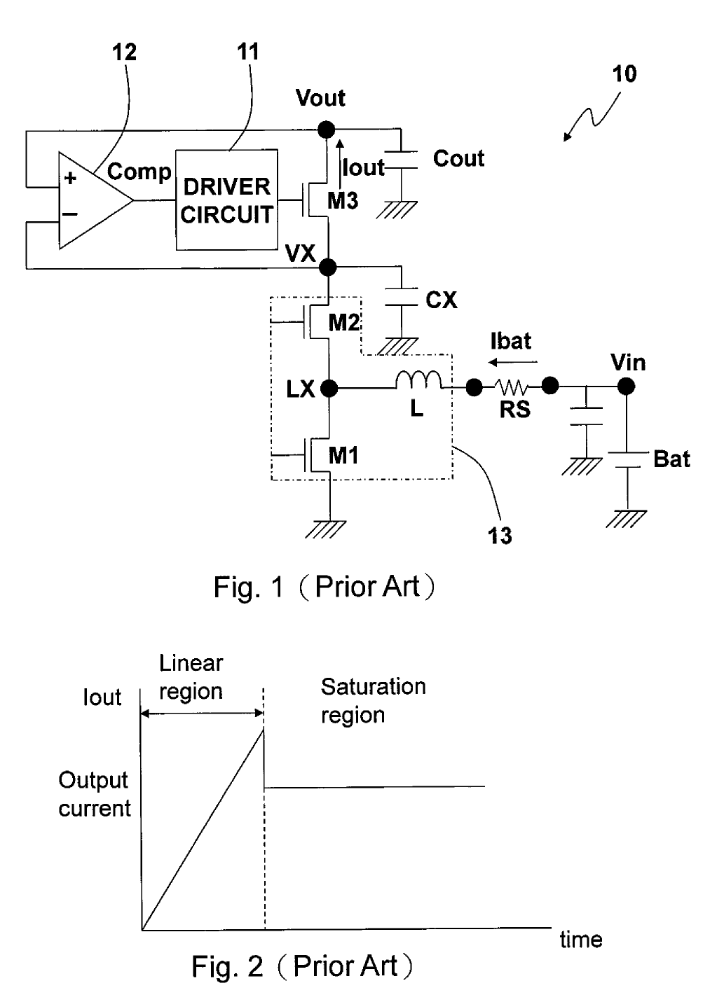

### DESCRIPTION OF THE PREFERRED EMBODIMENTS

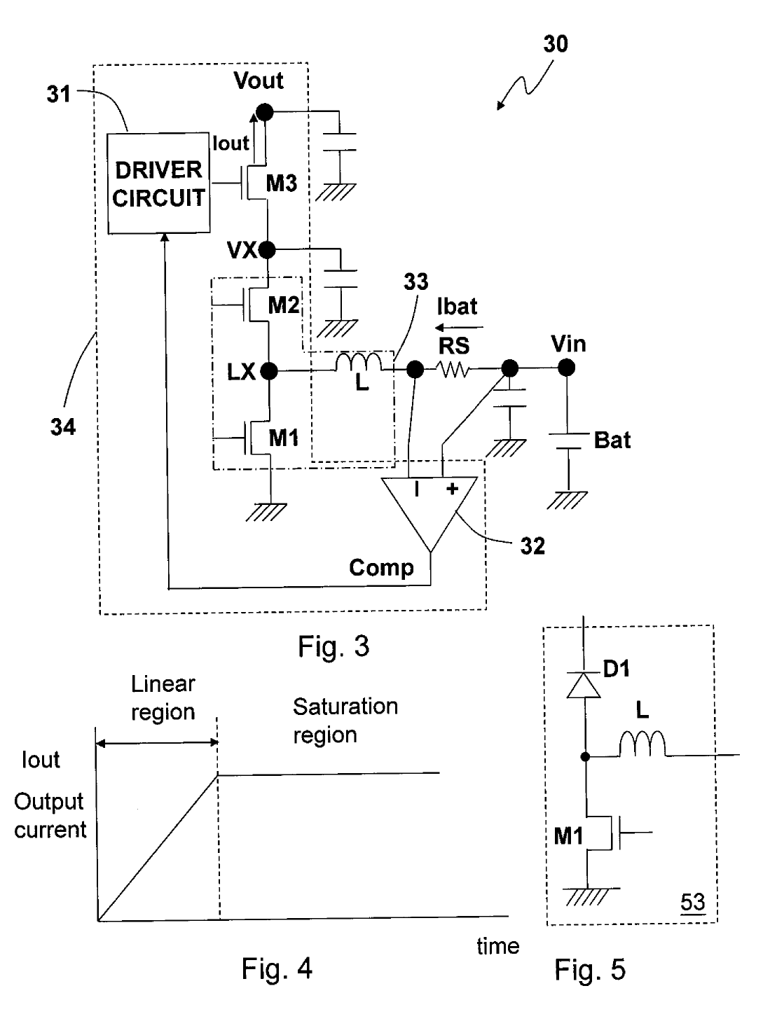

Please refer to FIG. 3 for a first embodiment of the present invention. As shown in the figure, in a power supply mode, a bi-directional switching regulator 30 converts a lower input voltage Vin to a higher output voltage Vout; the terminal of the input voltage Vin is connected to a battery Bat, and the terminal of the output voltage Vout is connected to a load. In a charger mode, the output terminal Vout can be connected to a power supply to charge the battery Bat.

The bi-directional switching regulator 30 includes a driver circuit 31, an error amplifier 32, a power stage 33, a load switch M3 and a resistor RS. The power stage 33 includes an upper gate switch M2, a lower gate switch M1 and an inductor L which are coupled to a common switching node LX. A current from the battery Bat flows through the resistor RS, the inductor L and the upper gate switch M2, and then flows through a node VX to the terminal of the output voltage Vout. The load switch M3 is controlled by the driver circuit 31 to adjust the output current Iout flowing to the terminal of the output voltage Vout.

When a short circuit or an abnormal overload occurs, the output current Iout becomes very large, and accordingly the input current from the input terminal (that is, the battery current Ibat) becomes very large also. Hence, the error amplifier 32 can detect a large voltage difference between two terminals of the resistor RS, and the voltage difference represents current information of the input current from the input terminal (the terminal of the input voltage Vin). The driver circuit 31 controls the load switch M3 according to an error signal Comp from the error amplifier 32, which indicates the current information, to control the output current Iout. Thus, the switching regulator 30 can control the output current Iout in direct response to the battery current Ibat, so as to effectively protect the battery Bat. The driver circuit 31 can adjust the output current Iout by changing a gate voltage Vgate of the load switch M3, or by changing a duty ratio of a pulse width modulation (PWM) signal controlling the load switch M3.

As shown in FIG. 3, the driver circuit 31, the error amplifier 32, the upper gate switch M2, the lower gate switch M1 and the load switch M3 can be integrated into a control circuit 34 in the form of one integrated circuit chip so that the switching regulator 30 can be constructed in a simpler way.

Referring to FIG. 4, when the load switch M3 is switching from a linear mode to a saturation mode, the load switch M3 is effectively controlled so that the output current Iout does not present an overshoot problem.

If it is not required for the switching regulator 30 to operate bi-directionally, that is, if it is not required for the switching regulator 30 to charge the battery Bat from the terminal connected with the output voltage Vout, the power stage 33 can be replaced by another power stage 53 shown in FIG. 5; that is, the upper gate transistor M2 can be replaced by a diode D1. The power switch 53 is also a boost switching regulator.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the switches in the present invention can be P-type or N-type devices. As another example, a device which does not affect the primary functions of the circuits can be interposed between two devices or circuits shown to be in direct connection in the illustrated embodiments. As yet another example, the positive and negative input terminals of the error amplifier can be swapped as long as corresponding modifications are made so that the input and output signals of the comparator are properly processed to provide a desired function. Thus, the present invention should cover all such and other modifications and variations, which should be interpreted to fall within the scope of the following claims and their equivalents.

What is claimed is:

1. A bi-directional switching regulator converting an input voltage to an output voltage in a power supply mode, the bi-directional switching regulator comprising:
a power stage including an upper gate switch, a lower gate switch and an inductor coupled to a common switching node, wherein the inductor is coupled to the input voltage;
a load switch coupled between the output voltage and the upper gate switch; and
a driver circuit controlling the load switch to adjust an output current flowing through the load switch according to current information at an input terminal of the input voltage.

2. The switching regulator of claim 1, further comprising a resistor coupled between the inductor and the input voltage, wherein the current information is a voltage difference between two terminals of the resistor.

3. The switching regulator of claim 2, further comprising an error amplifier comparing voltages at the two terminals of the resistor to generate an error signal which is sent to the driver circuit.

4. The switching regulator of claim 1, wherein both the upper gate switch and the lower gate switch are transistors.

5. The switching regulator of claim 1, wherein in a charger mode, the bi-directional switching regulator charges the input terminal of the input voltage from a terminal connected to the output voltage.

6. A control circuit of a bi-directional switching regulator, in a power supply mode, the control circuit controlling an input current from an input terminal through an inductor to generate an output current which is supplied to an output terminal, the control circuit comprising:
an error amplifier detecting a voltage difference related to the input current to generate a error signal;
a lower gate switch;
an upper gate switch coupled to the lower gate switch and the inductor at a common switching node;
a load switch coupled between the output terminal and the upper gate switch; and
a driver circuit controlling the load switch according to the error signal to adjust the output current flowing through the load switch.

7. The control circuit of claim 6, wherein the inductor is coupled with one terminal of a resistor, and another terminal of the resistor is coupled to the input terminal, wherein the voltage difference is a voltage difference between the two terminals of the resistor.

8. The control circuit of claim 7, wherein the error amplifier compares voltages at the two terminals of the resistor to generate the error signal.

9. The control circuit of claim 6, wherein both the upper gate switch and the lower gate switch are transistors.

10. The control circuit of claim 6, wherein in a charger mode, the bi-directional switching regulator charges the input terminal from the output terminal.
